(19) United States
(12) Patent Application Publication
(10) Pub. No.: US 2015/0155087 A1
(43) Pub. Date: Jun. 4, 2015

(54) TRANSFORMER

(71) Applicant: Hyundai Motor Company, Seoul (KR)

(72) Inventors: In Yong Yeo, Bucheon (KR); Byeong Seob Song, Yongin (KR); Dae Woo Lee, Uljin (KR); Jin Young Yang, Hanam (KR); Woo Young Lee, Chungcheongbuk-do (KR)

(21) Appl. No.: 14/314,709

(22) Filed: Jun. 25, 2014

(30) Foreign Application Priority Data
Dec. 4, 2013 (KR) 10-2013-0150228

(51) Int. Cl. H01F 27/00; H01F 27/28

(52) U.S. Cl. CPC H01F 27/008; H01F 27/2823

(57) ABSTRACT

A transformer is provided that includes a core and a coil part. The coil part includes primary and secondary coils that are wound on the core in different directions.

### CROSS-REFERENCE TO RELATED APPLICATION

This application claims under 35 U.S.C. §119(a) the benefit of Korean Patent Application No. 10-2013-0150228 filed Dec. 4, 2013, the entire contents of which are incorporated herein by reference.

### BACKGROUND

1. Field of the Invention

The present invention relates to a transformer which reduces a loss of energy through the production of heat by allowing a magnetic flux to be uniformly dispersed and distributed without being concentrated at any specific portion.

2. Description of the Related Art

A transformer is a device that transfers electric energy from one circuit to another through electrical insulation using an inductive electrical conductor. The transformer transfers electrical energy from one electrical circuit to another electrical circuit by enhancing or reducing a voltage. The transformer converts a voltage based on electromagnetic induction and transfers electric current by generating induction current on another coil, i.e. a secondary coil, when magnetic field lines are increased or reduced based on a variation in current that flows through a primary coil.

As shown in FIG. 6, in a transformer of the related art, since primary coils 10 and secondary coils 20 are wound on the upper and lower portions of the core 30 respectively, heat is concentrated at the portion 40 where magnetic fluxes from the primary and secondary sides overlap and increase eddy current, while the temperature of the upper and lower portions of the core is substantially low which may cause temperature problems. In addition, the recent issue is to reduce the size of magnetic members that occupy a substantial volume to reduce the size and weight of the system which directly related to a method of lowering the temperature of the magnetic members.

Therefore, there are increasing needs for the research and development of a structure that effectively dissipates heat from magnetic members. Typical approaches thereof include a molding method, a method of using a thermal sheet and a heat dissipation plate, and the like. Although the method of molding a magnetic member is significantly effective in lowering the temperature, a manufacturing cost and the overall volume of the magnetic member may be significantly increased since a plastic or aluminum case and a molding resin (e.g. silicones having a high thermal conductivity) are used. In the method of using a thermal sheet and a heat dissipation plate on the exterior of the magnetic member, only the temperature extraneous to the core is lowered. Therefore, the effect of this method in lowering the temperature inside the core or the temperature of the coils is insignificant. Therefore, there are needs for a transformer to which a novel winding method that reduces heat generated from the core and wires of the transformer without using an additional heat dissipation method is applied.

The foregoing is intended merely to aid in the understanding of the background of the present invention, and is not intended to mean that the present invention falls within the purview of the related art that is already known to those skilled in the art,

### SUMMARY

Accordingly, the present invention provides a transformer to which a novel winding method that may reduce heat generated from the core and wires of the transformer without using an additional heat dissipation method is applied.

In order to achieve the above object, according to one aspect of the present invention, a transformer may include: a core; and a coil part that has primary and secondary coils wound on the core in different directions. The primary coil may be wound in a right downward direction and the secondary coil may be wound in a left downward direction. The coil part may have an X-shaped configuration in which the primary coil may be wound in a right downward direction and the secondary coil may be wound in a left downward direction. The coil part may be a plurality of coil parts.

In the transformer according to the present invention having the above described structure, the primary and secondary coils which are nonparallelly wound (e.g., not wound in parallel) on the upper and lower portions may serve to disperse heat which reduce heat generated at the core and the substantially central portion of the coil parts to reduce the maximum temperature while increasing heat at the upper and lower portions to achieve the effect of heat dispersion. In addition, it may be possible to reduce heat generated from the magnetic members without increasing the size and cost since none of the several methods of the related art are used, Since the magnetic members may be designed in a smaller size than the related art, a more compact design of the transformer may be achieved.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is an exemplary view showing a transformer according to an exemplary embodiment of the present invention;

FIG. 2 is an exemplary front elevation view of the transformer shown in FIG. 1 according to an exemplary embodiment of the present invention;

FIG. 3 and FIG. 4 are exemplary views showing thermal imaging measurement results of a related art transformer and the transformer according to an exemplary embodiment of the present invention;

FIG. 5 is an exemplary view of the transformer according to another exemplary embodiment of the present invention; and

FIG. 6 is an exemplary view of a transformer of the related art.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be thither understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

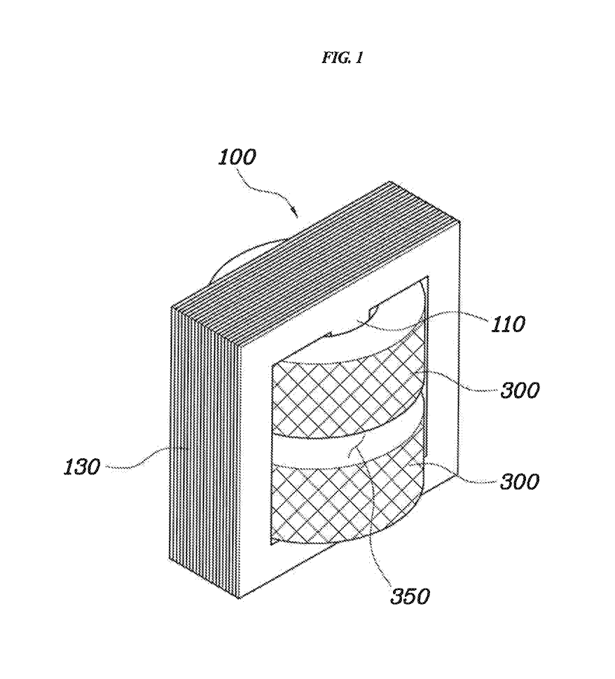

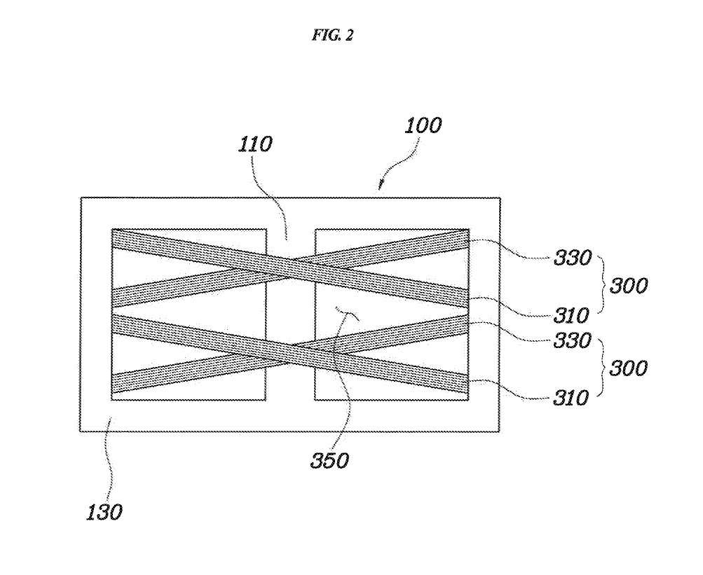

Hereinbelow, exemplary embodiments of a transformer according to the present invention will be described in detail with reference to the accompanying drawings, FIG. 1 is an exemplary view showing a transformer according to an exemplary embodiment of the present invention, and FIG. 2 is an exemplary front elevation view of the transformer shown in FIG. 1.

A transformer according to an exemplary embodiment of the present invention may include a core 100 and a coil part 300. The coil part 300 may include a primary coil 310 and a secondary coil 330 wound on the core 100 in different directions. The core 100 may include a central portion 110 that extends in a top-bottom direction (e.g., vertical direction) and a circumferential portion 130 that surrounds the coil part 300 from above and below and from the right and left. The primary coil 310 and the secondary coil 330 may be wound on the substantially central portion 110 of the core 100 in different directions.

Describing the coil part 300 in more detail, the primary coil 310 may be wound on the central portion 110 of the core 100 in the right downward direction and the secondary coil 330 may be wound on the central portion 110 of the core 100 in the left downward direction, to form the shape of an “X.” It may be possible to provide a plurality of coil parts 300 each of which has the shape of an “X.” The direction in which either the primary coil 310 or the secondary coil 330 of the coil part 300 is wound may be changed freely depending on the design or condition so long as the primary coil 310 and the secondary coil 330 are wound nonparallelly, that is, not parallel to each other, such that magnetic fluxes do not overlap.

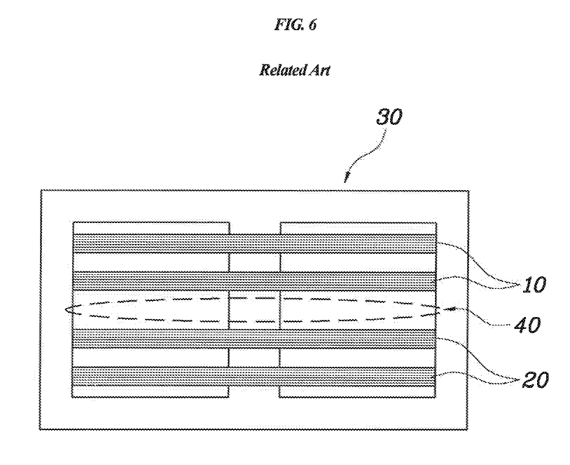

In the related art as shown in FIG. 6, when the primary coils 10 and the secondary coils 20 are wound on the central portion of the core 30, the primary coils 10 are wound on the upper portion in the transverse direction, d the secondary coils 20 are wound on the lower portion in the transverse direction. Thus, a substantial amount of eddy current is generated at the central portion 40 where magnetic fluxes overlap, thus raising the temperature. When the temperature is increased to or greater than a reference temperature, the system may have a temperature problem and malfunction.

In contrast, the transformer according to this exemplary embodiment has the primary coil 310 and the secondary coil 330 which may be wound in a non-parallel manner on the central portion 110 of the core 100 to prevent the magnetic fluxes from overlapping at a substantially central portion 350 between the primary coil 310 and the secondary coil 330. Accordingly, heat may be dispersed more evenly to the upper and lower portions of the transformer to prevent the temperature from being concentrically raised at the central portion 350, thus reducing overall heat of the system.

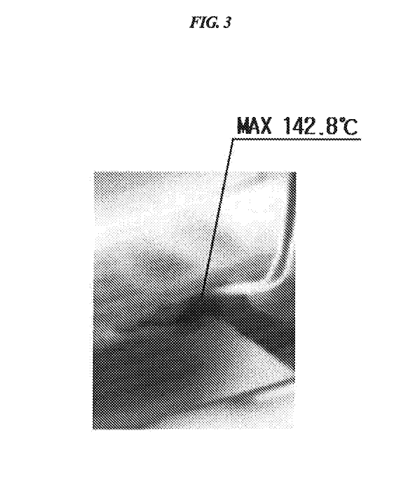

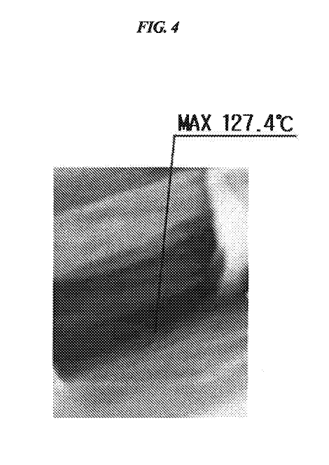

Referring to FIG. 3 and FIG. 4 that show the thermal images of the related-art transformer and the transformer according to the present invention taken using a thermal imaging device, the related-art transformer shown in FIG. 3 exhibits a maximum temperature of 142.8° C. since heat is concentrated at the central portion, whereas the transformer according to the present invention exhibits a maximum temperature of about 127.4° C. since heat is dispersed to the upper and lower portions. The transformer according to the present invention may decrease the maximum temperature of the central portion 350 by 15.5° C. Further, the primary and secondary coils which may be wound in a non-parallel orientation on the upper and lower portions may serve to disperse heat which may reduce heat generated at the core and the central portion of the coil parts to lower the maximum temperature while increasing heat at the upper and lower portions to achieve the effect of heat dispersion. In addition, it may be possible to reduce heat generated from the magnetic members without increasing the size and cost since none of the several methods of the related art are used. Since the magnetic members may be designed in a smaller size, a more compact design of the transformer may be achieved.

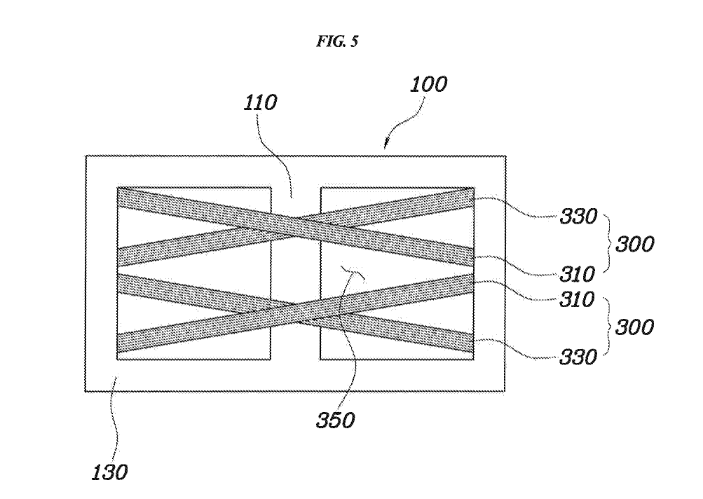

As shown in FIG. 5, a transformer according to another exemplary embodiment of the present invention may include a plurality of coil parts along the substantially central portion of the core. In particular, one of the coil parts (e.g., a first coil part) may have an X-shaped configuration in which the primary coil 310 may be wound in a right downward direction and the secondary coil 320 may be wound in a left downward direction to the upright central portion 110 of the core 100. In addition, another of the coil parts (e.g., a second coil part) adjacent to the first may have an X-shaped configuration in which the primary coil 310 may be wound in a left downward direction and the secondary coil 320 may be wound in a right downward direction to the upright central portion 110 of the core 100.

Although exemplary embodiments of the present invention has been described fir illustrative purposes, those skilled in the art will appreciate that various modifications, additions and substitutions are possible, without departing from the scope and spirit of the present invention as disclosed in the accompanying claims.

What is claimed is:

1. A transformer, comprising:
a core; and
a coil part that includes a primary coil and a secondary coil that are wound on the core in different directions.

2. The transformer according to claim 1, wherein the primary coil is wound in a right downward direction to the upright central portion of the core.

3. The transformer according to claim 1, wherein the secondary coil is wound in a left downward direction to the upright central portion of the core.

4. The transformer according to claim 1, wherein the coil part has an X-shaped configuration in which the primary coil is wound in a right downward direction and the secondary coil is wound in a left downward direction to the upright central portion of the core.

5. The transformer according to claim 1, wherein the coil part includes a plurality of coil parts.

6. The transformer according to claim 1, wherein the coil part has an X-shaped configuration in which the primary coil is wound in a right downward direction and the secondary coil is wound in a left downward direction to the upright central portion of the core, and the coil part includes a plurality of coil parts disposed along the central portion of the core.

7. The transformer according to claim I, wherein the coil part includes:
a plurality of coil parts disposed along the central portion of the core,
wherein a first coil part of the plurality of coil parts has an X-shaped configuration in which the primary coil is wound in a right downward direction and the secondary coil is wound in a left downward direction to the upright central portion of the core, and
wherein a second coil part of the plurality of coil parts adjacent to the first coil part has an X-shaped configuration in which the primary coil is wound in a left downward direction and the secondary coil is wound in a right downward direction to the upright central portion of the core.
